(19) United States
(12) Patent Application Publication
(10) Pub. No.: US 2019/0136539 A1
(43) Pub. Date: May 9, 2019

(54) TOWER STEP PEGS HAVING SAFETY LOCKS

(71) Applicant: Roger Davis, Lakeland, FL (US)

(72) Inventor: Roger Davis, Lakeland, FL (US)

(21) Appl. No.: 16/021,826

(22) Filed: Jun. 28, 2018

Related U.S. Application Data
(60) Provisional application No. 62/526,411, filed on Jun. 29, 2017.

(51) Int. Cl. E04F 11/022; F16B 39/24; E04H 12/00

(52) U.S. Cl. CPC E04F 11/0223; E04H 12/00; F16B 39/24

(57) ABSTRACT

Some implementations can include step pegs having safety locks.

### RELATED APPLICATIONS

This application claims the benefit of U.S. Application No. 62/526,411, filed on Jun. 29, 2017, and entitled “Tower Step Pegs Having Safety Locks,” which is incorporated herein by reference in its entirety.

### TECHNICAL FIELD

Some implementations relate generally to step pegs for climbing utility towers, and more particularly, to utility tower step pegs having safety locks.

### BACKGROUND

Conventional tower step pegs (e.g., FIG. 5) are designed to slip into a metal sleeve protruding from a tower (e.g., a utility tower such as a cell tower or power tower). The conventional step pegs are not locked or secured in place, but rather held in place by gravity. Accordingly, the conventional step pegs are susceptible to coming out of the sleeve. Because of the danger of the conventional step pegs coming out, they are sometimes referred to as “suicide pegs.”

Some implementations were conceived in light of the above mentioned needs and limitations, among other things.

### BRIEF DESCRIPTION OF THE DRAWINGS

FIG. 1 is a side view of an example step peg in accordance with some implementations.

FIGS. 2A and 2B show a side and top view, respectively, of an example step peg safety lock washer in accordance with some implementations.

FIG. 3 is an exploded end view of an example step peg and safety lock in accordance with some implementations.

FIG. 4 is a picture of the triangular shaped end of a step peg in accordance with some implementations.

FIG. 5 is a picture of a conventional step peg.

FIG. 6 is a diagram augmented picture of the step peg of FIG. 5 showing a step peg having the safety lock features in accordance with some implementations.

### DETAILED DESCRIPTION

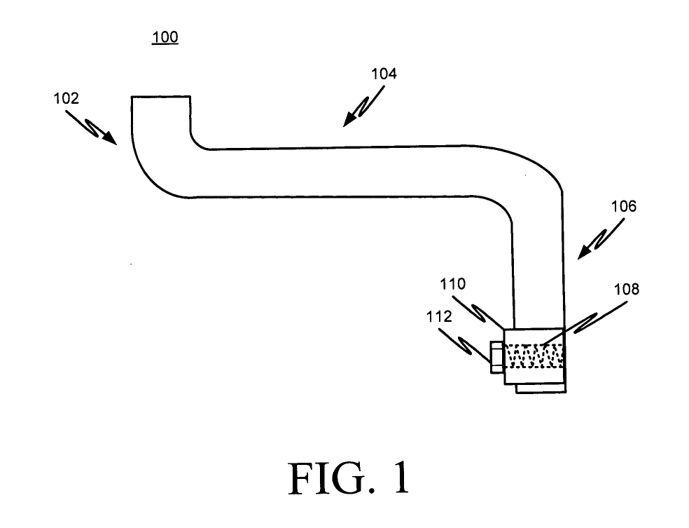

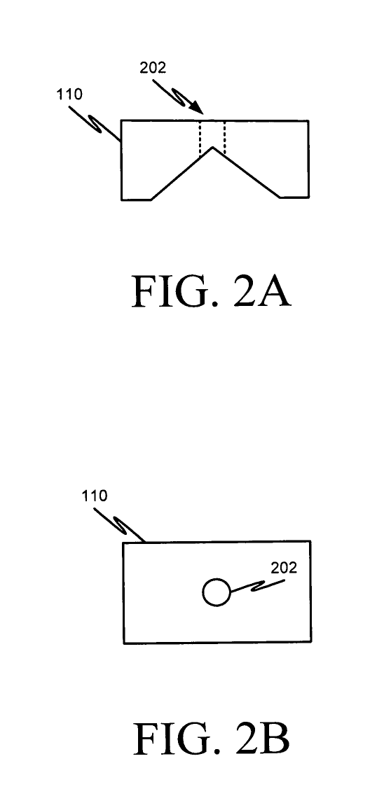

FIG. 1 is a side view of an example step peg 100 having a first vertical section 102, a horizontal section 104 and a second vertical section 106 having a partially “V” shaped cross section at a distal end. The step peg 100 also includes a threaded hole 108 near the distal end of the second vertical section 106, a lock washer 110 configured to conform to the “V” shaped cross section of the distal end of the second vertical section 106, and a bolt 112 configured to secure the lock washer 110 to the second vertical section 106 by passing through a hole (see, 202 in FIGS. 2A and 2B) in the lock washer 110 and threading into the threaded holed 108 near the distal end of the second vertical section 106.

The first vertical section 102 can be about 2 inches high. The horizontal section 104 can be about 8 inches long, and the second vertical section can be about 5¼ inches high, which can include about 3¼ inches of partially triangular cross section at the distal end. The step peg 100 can be formed from ¾ inch round steel stock. The bolt 112 can include a ⅜ inch bolt, and the threaded aperture 202 can be threaded so as to be mechanically compatible with the threads on the bolt 112. The lock washer 110 can be about 1 inch wide by 1¼ inches long by ¾ inch high and can be formed from galvanized steel or other suitable material. It will be appreciated that the dimensions presented above are non-limiting examples for illustration purposes. Other dimensions could be used.

FIGS. 2A and 2B show a side and top view, respectively, of an example step peg safety lock washer 110 and the aperture 202 in the lock washer 110 through which the bolt 112 can pass.

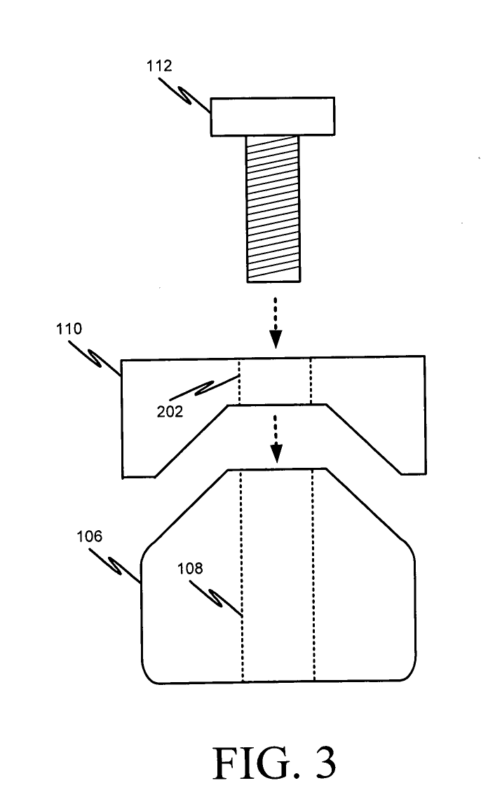

FIG. 3 is an exploded end view of an example step peg 100 showing the safety lock formed by the bolt 112 and the lock washer 110 that are attached to the distal end of the second vertical section 106 of the step peg 100 after the second vertical section of the step peg has been inserted into a sleeve projecting from the side of a tower (or other structure). The bolt 112 holds the lock washer 110 in place via threaded engagement between the bolt 112 and the threaded hole 108 in the distal end of the second vertical section 106 of the step peg 100. The lock washer 110 is of sufficient size so as to prevent the second vertical section from slipping out of the sleeve on the tower and thus increases the safety of the step peg.

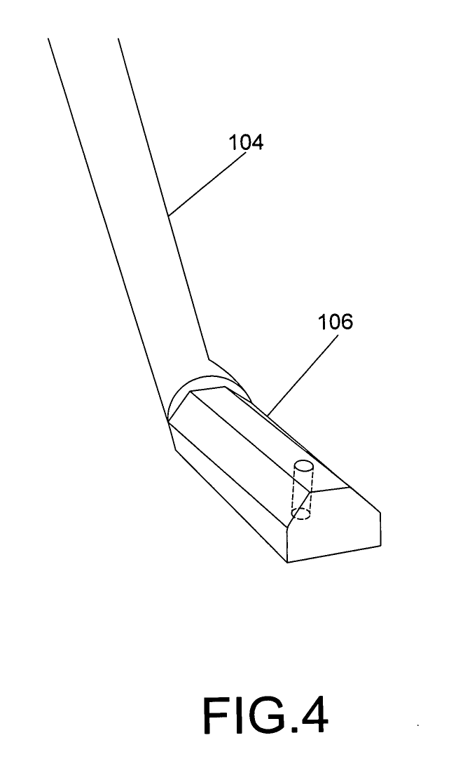

FIG. 4 is a picture of the partially triangular shaped cross section of the second vertical section 106 of a step peg.

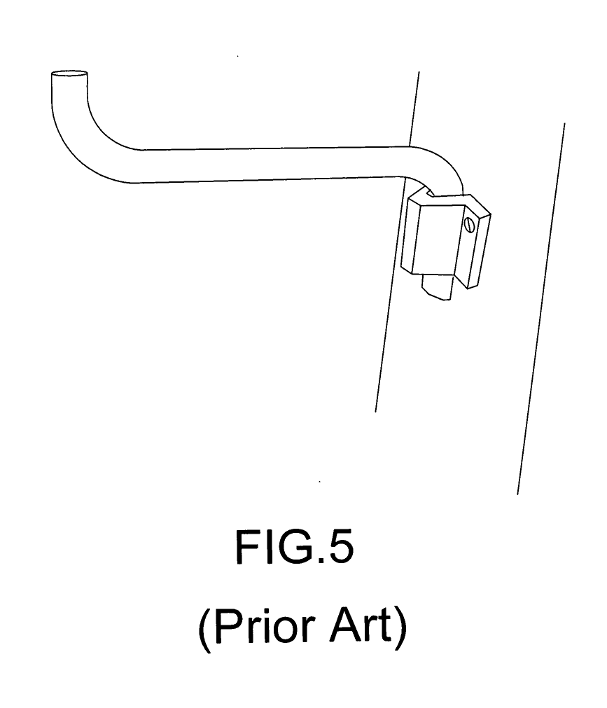

FIG. 5 is a picture of a conventional step peg. As can be seen in FIG. 5, conventional step pegs do not extend very far past the bottom opening of the sleeve protruding from the tower. Also, there is no element that locks the step peg into place and prevents it from coming out of the sleeve.

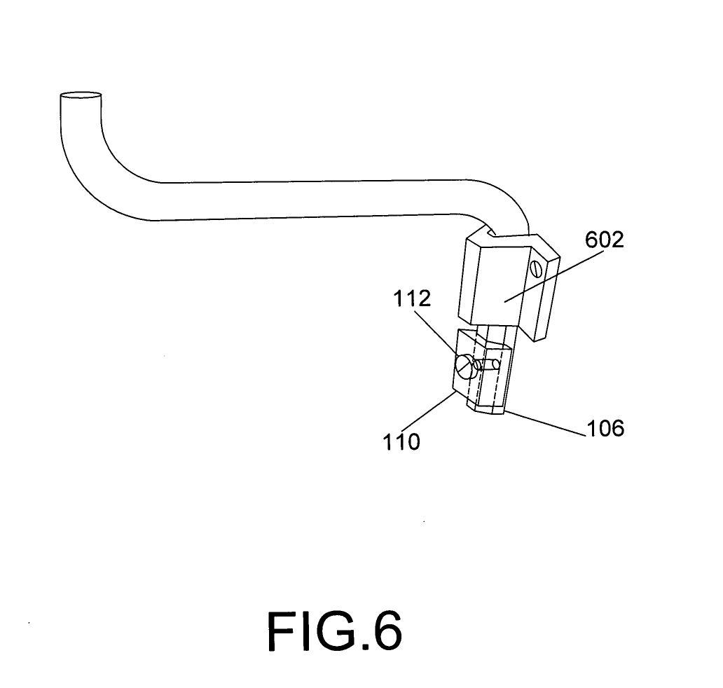

FIG. 6 is a diagram augmented picture of the step peg of FIG. 5 showing a step peg having the safety lock features of the present disclosure. In particular, as shown in FIG. 6, the distal end of the second vertical section 106 of the step peg extends beyond the typical length of a conventional step peg to accommodate the lock washer 110 and the bolt 112. Also, the end of the lock washer 110 that is designed to abut the sleeve protruding from the tower can have an angled top 602 that is compatible with the angle of the sleeve and permits the lock washer to fit snugly against the sleeve protruding from the tower.

It is, therefore, apparent that there is provided, in accordance with the various embodiments disclosed herein, step pegs having safety locks.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A tower foot peg comprising:
a first vertical section;
a horizontal section;
a second vertical section having a “V” shaped cross section at a distal end of the second vertical section, wherein the second vertical section includes a threaded hole adjacent the distal end of the second vertical section;
a lock washer configured to conform to the “V” shaped cross section of the distal end of the second vertical section; and
a bolt configured to secure the lock washer to the second vertical section by passing through a hole in the lock washer 110 and threading into the threaded holed of the second vertical section.

2. The tower foot peg of claim 1, wherein an end of the lock washer is constructed to abut a sleeve protruding from a tower, and have an angled top that is compatible with an angle of the sleeve to permit the lock washer to fit snugly against the sleeve protruding from the tower.

3. The tower foot peg of claim 2, wherein the lock washer is of sufficient size to prevent the second vertical section from slipping out of the sleeve on the tower and thus increase the safety of the step peg.
